(19) United States
(12) Patent Application Publication
(10) Pub. No.: US 2011/0005658 A1
(43) Pub. Date: Jan. 13, 2011

(54) Border Hanger

(76) Inventor: Linda Saker, Front Royal, VA (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/501,013

(22) Filed: Jul. 10, 2009

(51) Int. Cl. B32B 37/12

(52) U.S. Cl. 156/71; 156/391

(57) ABSTRACT

An embodiment of the present invention includes an apparatus that allows an individual to apply a wallpaper border to a vertical surface. The apparatus holds the pre-moistened wallpaper border, includes a reservoir to collect excess water, and a device to attach the border hanger cylinder to a vertical surface so that the individual may apply the wallpaper border to the surface without the assistance of another individual if so desired.

### FIELD OF THE INVENTION

This invention relates to hanging a wallpaper border. More specifically, this invention relates to an apparatus and method for hanging the wallpaper border.

### BACKGROUND OF THE INVENTION

Wallpaper has been used to provide decorative wall covering for centuries. A wallpaper border is a more recent variation on traditional wallpaper. The wallpaper border comes in a range of sizes from a few inches in width to around a foot in width. Wallpaper borders are applied to a portion of a smooth surface such as a wall, to carry a decorating scheme onto the walls of a room. The wallpaper border is only applied to a portion of the wall, therefore it provides a means of decorating that is quicker and easier than wallpapering the entire wall or the entire room.

Wallpaper borders are most often sold in rolls and backed with an adhesive that is activated when it is moistened much like traditional wallpaper. The wallpaper border roll is immersed in water to activate the adhesive. However, excess water dripping from the roll leads to messy application of the wallpaper border to the surface.

Most often the wallpaper border is applied to the top of the wall right where it meets the ceiling. Therefore, it is very difficult and extremely time consuming for one person to apply the wallpaper border without assistance. At least two people and two ladders are necessary to apply the border to the wall, so that one person can hold the unused portion of the wallpaper border roll while the other person positions and smoothes the wallpaper border.

Therefore, it is desirable to have an apparatus and a method to allow an individual to apply a wallpaper border without assistance and at the same time decrease time and the mess associated with hanging the wallpaper border.

### SUMMARY

The foregoing needs are met, to a great extent by the present invention, wherein in one aspect an apparatus is provided that in some embodiments allows an individual to neatly hang a wallpaper border in a brief amount of time.

In accordance with one embodiment of the present invention, a border hanger to apply a pre-moistened wallpaper border to a surface is provided and can include a container having a solid bottom plate and a side wall defining a top opening. A dowel can be attached to a center point on the bottom plate and the dowel extends from the bottom plate to a point above a top edge of the side wall, at least one longitudinal slit defined by the side wall and extending from a point above the bottom plate to the top edge of the side wall. The border hanger also includes a handle attached to an outside surface of the side wall. A hook can also be included for securing the container to the surface as well as a water collection portion that receives water from the pre-moistened wallpaper border.

In accordance with another embodiment of the present invention, a border hanger to apply a pre-moistened wallpaper border to a surface is provided and can include a container having a solid bottom plate and a side wall defining a top opening. A dowel can be attached to a center point on the bottom plate and extends from the bottom plate to a point above a top edge of the side wall. The border hanger also includes at least one longitudinal slit defined by the side wall and extending from a point above the bottom plate to the top edge of the side wall and a handle attached to an outside surface of the side wall. A suction cup can also be included to secure the container to the surface, as well as a water collection portion to receive water from the pre-moistened wallpaper border roll.

In accordance with yet another embodiment of the present invention, a method for applying a pre-moistened wallpaper border to a surface is provided and can include placing the pre-moistened wallpaper border into a container having a solid bottom plate, a side wall, and a dowel attached to a center point on the bottom plate, such that said wallpaper border roll is wrapped around the dowel. The method can also include threading the pre-moistened wallpaper border through a longitudinal slit defined by the side wall, adhering the pre-moistened wallpaper border to the surface and using a handle attached to an outside surface of the side wall to pull the container thereby unwrapping the pre-moistened wallpaper border. Additionally, the method can include hanging the container using a hanging device such that an individual can smooth the pre-moistened wallpaper border onto the surface.

There has thus been outlined rather broadly, certain embodiments of the invention in order that the detailed description thereof herein may be better understood, and in order that the present contributions to the art may be better appreciated. There are of course additional embodiments of the invention that will be described below and which will form the subject matter of the claims appended hereto.

In this respect before explaining at least one embodiment of the invention in detail it is to be understood that the invention is not limited in its application to the details of construction or arrangements of the components set forth in the following description or illustrated in the drawings. The invention is capable of embodiments in addition to those described and of being practiced and carried out in various ways. Also, it is to be understood that the phraseology and terminology employed herein, as well as in the abstract, are for the purpose of description and should not be regarded as limiting.

As such, those skilled in the art will appreciate that the conception upon which this disclosure is based may be utilized readily as a basis for the designing of other structures, methods, and systems for carrying out the several purposes of the present invention. It is important therefore that the claims be regarded as including such equivalent constructions insofar as they do not depart from the spirit and scope of the present invention.

### BRIEF DESCRIPTION OF THE DRAWINGS

FIG. 1 is a side view illustrating the border hanger according to an embodiment of the invention;

FIG. 2 is a cross-sectional view of the embodiment illustrated in FIG. 1;

FIG. 3 is a top view of the embodiment illustrated in FIGS. 1 and 2;

FIG. 4 is a cross-sectional view illustrating a device to hang the border hanger according to an embodiment of the invention;

FIG. 5 is a partially cross-sectional view illustrating another attachment device to hang the border hanger according to an embodiment of the invention; and

FIG. 6 is a view illustrating the border hanger being used to apply a wallpaper border to a wall in accordance with an embodiment of the invention.

### DETAILED DESCRIPTION

An embodiment of the present invention includes an apparatus that allows an individual to apply a wallpaper border to a surface. The apparatus holds the pre-moistened wallpaper border, includes a reservoir to collect excess water, and a device to attach the border hanger to a surface so that the individual may apply the wallpaper border to the surface.

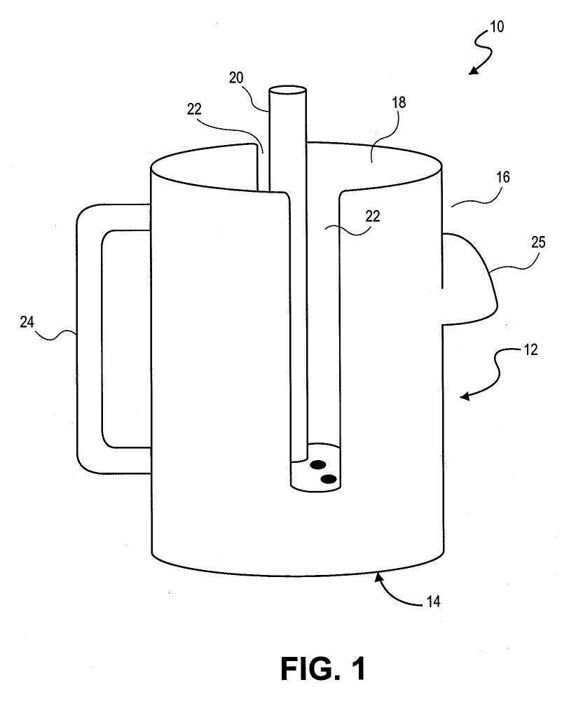

An embodiment of the present invention is illustrated in FIG. 1. FIG. 1 is a side view illustrating the border hanger according to an embodiment of the invention. The border hanger 10 includes a cylindrical container 12. The cylindrical container 12 has a circular bottom plate 14 and a side wall 16 that defines a circular top opening 18. The container, the bottom plate, and the top opening may also take the form of a number of different shapes such as a triangle or a square. A dowel 20 is attached to a point at the center of the circular bottom plate 14, extends from the circular bottom plate 14 to a point just above a top edge of the side wall 16, and is parallel to the side wall 16. At least one longitudinal slit 22 extends from a point on the side wall 16 just above the circular bottom plate 14 to the top edge of the side wall 16. FIG. 1 also illustrates two longitudinal slits 22 located on opposite sides of the cylindrical container 12. However, this should not be considered a limitation on the number or placement of the longitudinal slits.

A handle 24 is attached to an outside surface of the side wall 16, to allow an individual to easily use the border hanger 10. For example, the handle is located on the side wall 16 at a position approximately 90 degrees from the position of the longitudinal slit 22. A coupler 25 is also mounted on the side wall 16, and defines a space such that the individual using the border hanger 10 may mount the border hanger 10 on the wall using a device to hang the border hanger 10 such as a hook or a suction cup.

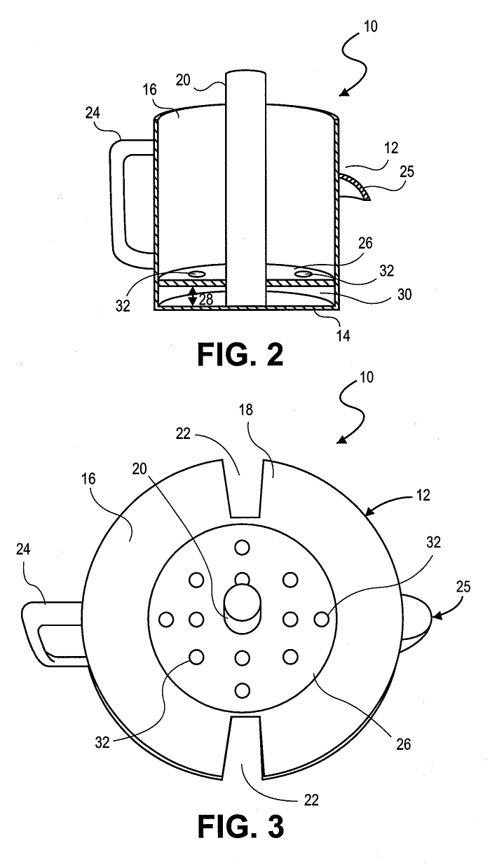

FIG. 2 is a cross-sectional view of the embodiment illustrated in FIG. 1 and FIG. 3 is a top view of the embodiment illustrated in FIGS. 1 and 2. FIGS. 2 and 3 illustrate a device to collect excess water from the pre-moistened wallpaper border. The device to collect the excess water from the pre-moistened wallpaper border includes a circular drainage plate 26 mounted in the cylindrical container 12 at a predetermined distance 28 above the circular bottom plate 14 to create a reservoir 30 between the circular drainage plate 26 and the circular bottom plate 14. The circular drainage plate 26 defines a plurality of drainage holes 32. The drainage holes 32 allow for the excess water on the pre-moistened wallpaper border to drain into the reservoir 30 and keep it away from the wallpaper border, eliminating much of the mess associated with hanging the pre-moistened wallpaper border. Therefore, the wallpaper border roll is not sitting in water in the container 12 and, in turn, that water will not end up dripping down the wall. The dowel 20 may extend through an opening defined by the circular drainage plate 26. Alternately, the dowel 20 may be attached directly to a center point on the circular drainage plate 26. The border hanger 10 may be formed from many materials, but may be formed from molded plastic.

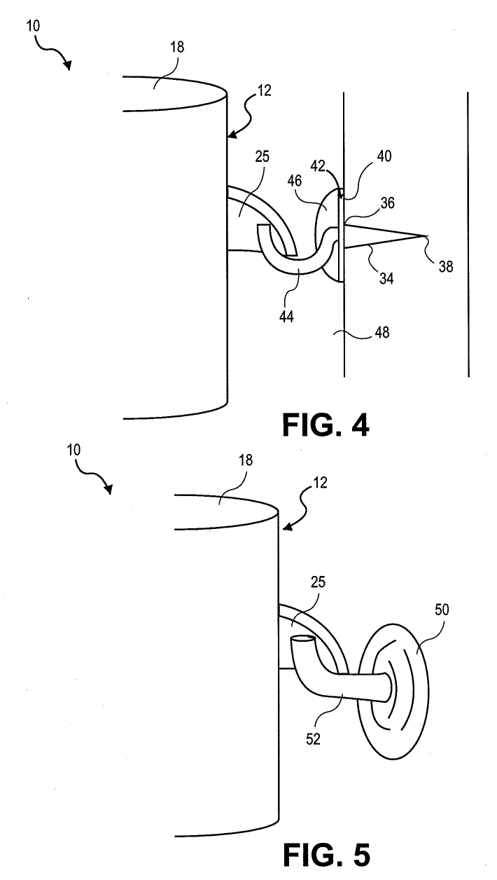

FIG. 4 is a cross-sectional view of an embodiment of a device to hang the border hanger in accordance with the present invention. FIG. 4 illustrates a sharp fitting 34 having a distal end 36 and a proximal end 38. The distal end 36 of the fitting 34 is attached to a back face 40 of a stop plate 42. The stop plate 42 prevents the fitting 34 from being pushed too far into a surface such as a wall 48. A hook 44 is attached to a front face 46 of the stop plate 42. The proximal end 38 of the fitting 34 is sharp, such that it can puncture the wall 48. Also, the length from the proximal end 36 to the distal end 38 of the fitting 34 is sufficient to secure the hook 44 and the stop plate 42 firmly to the wall 48. The fitting 34 may also be removed from the wall 48 if the individual pulls on the hook 44. Therefore, the fitting 34 may be easily repositioned on the wall or removed completely when that portion of the wall is to be covered with the wallpaper border. The hook 44 fits within the coupler 25, such that the border hanger 10 can be suspended from the hook 44. The hook 44 may have a weight bearing load of at least 5 pounds.

FIG. 5 is a partially cross-sectional view illustrating another embodiment of a device to hang the border hanger in accordance with the present invention. FIG. 5 illustrates a suction cup 50 that can be mounted on a wall or other flat surface to which a wallpaper border may be applied. The suction cup 50 has a hook 52 which fits within the coupler 25 of the border hanger 10, such that the border hanger 10 may be suspended from the hook 52.

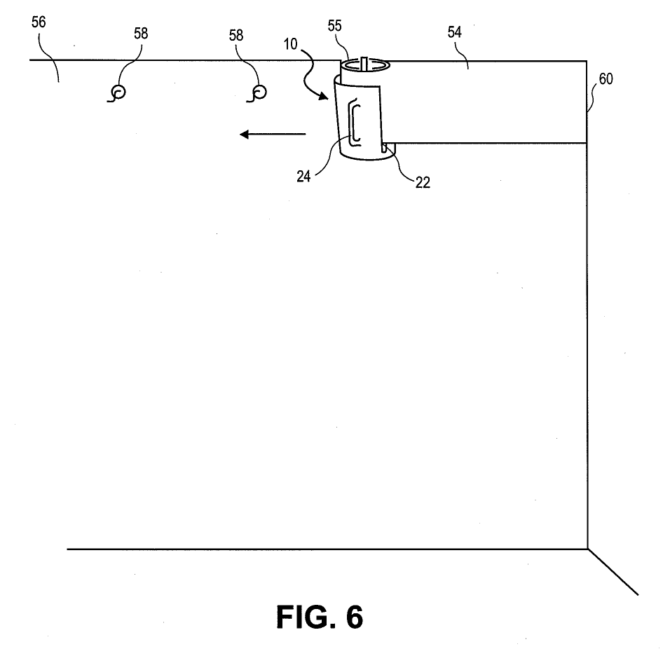

FIG. 6 is a view illustrating the border hanger being used in accordance with an embodiment of the invention. FIG. 6 illustrates the border hanger 10 being used to apply a wallpaper border 54 to a wall 56. First, an individual can mount several hooks 58 on the wall 56 a predetermined distance from one another. The hooks 58 can have a sharp fitting to puncture a surface such as the wall 56 and hold the hook 58 in place or can be attached to a suction cup. Additionally, the hooks 58 may be placed on the wall such that any puncture marks left by the hooks are covered when the wallpaper border 54 is applied to the wall.

A roll of wallpaper border 55 is pre-moistened and then placed in the container 12. The wallpaper border roll 55 wraps around the dowel 20. An end 60 of the wallpaper border 54 is threaded through one of the longitudinal slits 22, and a side of the wallpaper border 54 backed with adhesive is applied to the wall 56. The individual may thread the wallpaper border 54 through any of the slits 22 depending on factors such as whether the individual is left or right handed or on which end of the wall she starts hanging the wallpaper border. The individual may pull the border hanger 10 along the wall using the handle 24 until she reaches the next hook 58 on the wall 56. The individual may also hang the border hanger 10 from the hook 58 using the coupler 25. With the border hanger 10 hanging from the hook 58 on the wall 56, the individual then has both hands free to smooth any bubbles from the wallpaper border applied to the wall as well as wipe off any excess water from the wallpaper border or the wall.

After the individual has finished smoothing the wallpaper border, she can remove the hook the border hanger is hanging from and repeat the process by pulling the border hanger 10 to the next hook 58. While the wallpaper border 54 is being applied to the wall 56, excess water dripping off of the pre-moistened wallpaper border roll in the container drips through the drainage holes and is contained in the reservoir.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A border hanger to apply a pre-moistened wallpaper border to a surface, comprising:
a container having a solid bottom plate and a side wall defining a top opening;
a dowel attached to a center point on the bottom plate and extending from the bottom plate to a point above a top edge of the side wall;
at least one longitudinal slit defined by the side wall and extending from a point above the bottom plate to the top edge of the side wall;
a handle attached to an outside surface of the side wall;
a hook for securing the container to the surface; and
a water collection portion that receives water from the pre-moistened wallpaper border.

2. The border hanger of claim 1, wherein the hook comprises a weight bearing load of five pounds.

3. The border hanger of claim 1, wherein the pre-moistened wallpaper border wraps around the dowel.

4. The border hanger of claim 1, wherein the border hanger comprises molded plastic.

5. The border hanger of claim 1, wherein the hook comprises a sharp fitting.

6. The border hanger of claim 1, wherein the water collection portion comprises a drainage plate placed above the solid bottom plate to define a reservoir.

7. The border hanger of claim 5, wherein the hook comprises a fitting that punctures the surface and an individual hangs the border hanger from the hook.

8. The border hanger of claim 6 wherein, said drainage plate comprises one or more drainage holes.

9. A border hanger to apply a pre-moistened wallpaper border to a surface, comprising:
a container having a solid bottom plate and a side wall defining a top opening;
a dowel attached to a center point on the bottom plate and extending from the bottom plate to a point above a top edge of the side wall;
at least one longitudinal slit defined by the side wall and extending from a point above the bottom plate to the top edge of the side wall;
a handle attached to an outside surface of the side wall;
a suction cup to secure the container to the surface; and
a water collection portion that receives water from the pre-moistened wallpaper border roll.

10. The border hanger of claim 9, wherein the suction cup is coupled to the outside surface of the side wall.

11. The border hanger of claim 9, wherein the pre-moistened wallpaper border roll wraps around the dowel.

12. The border hanger of claim 9, wherein the border hanger comprises molded plastic.

13. The border hanger of claim 9, wherein the water collection portion comprises a drainage plate placed above the solid bottom plate to define a reservoir.

14. The border hanger of claim 13, wherein the drainage plate comprises one or more drainage holes.

15. A method for applying a pre-moistened wallpaper border to a surface, comprising:
placing the pre-moistened wallpaper border into a container having a solid bottom plate, a side wall, and a dowel attached to a center point on the bottom plate, such that said wallpaper border roll is wrapped around the dowel;
threading the pre-moistened wallpaper border through a longitudinal slit defined by the side wall;
adhering the pre-moistened wallpaper border to the surface;
using a handle attached to an outside surface of the side wall to pull the container thereby unwrapping the pre-moistened wallpaper border; and
hanging the container using a hanging device such that an individual can smooth the pre-moistened wallpaper border onto the surface.

16. The method of claim 15, further comprising placing hooks having a sharp fitting to puncture the surface and hold the hook in place on the surface.

17. The method of claim 16, further comprising placing the hooks at predetermined intervals along a length of the surface.

18. The method of claim 16, further comprising placing the hooks on the surface in an area to be covered by the wallpaper border.

19. The method of claim 15, further comprising collecting the excess water from the pre-moistened wallpaper border using a drainage plate placed above the solid bottom plate to define a reservoir.

20. The method of claim 19, wherein the drainage plate comprises one or more drainage holes.
